(19) United States
(12) Patent Application Publication
(10) Pub. No.: US 2025/0335758 A1
(43) Pub. Date: Oct. 30, 2025

(54) Apparatus and System for Providing Optical Real-Time Information Regarding a Process by Means of an Optical Neural Network as well as Method for Providing the Apparatus

(71) Applicants: Fraunhofer-Gesellschaft zur Förderung der angewandten Forschung e.V., Muenchen (DE); Rheinisch-Westfälische Technische Hochschule (RWTH) Aachen, Aachen (DE)

(72) Inventors: Paul BUSKE, Aachen (DE); Carlo HOLLY, Aachen (DE); Jochen STOLLENWERK, Aachen (DE); Annika (née VÖLL) BONHOFF, Aachen (DE)

(73) Assignees: Fraunhofer-Gesellschaft zur Förderung der angewandten Forschung e.V., Muenchen (DE); Rheinisch-Westfälische Technische Hochschule (RWTH) Aachen, Aachen (DE)

(21) Appl. No.: 19/260,567

(22) Filed: Jul. 6, 2025

Related U.S. Application Data
(63) Continuation of application No. PCT/EP2024/050127, filed on Jan. 4, 2024.

(30) Foreign Application Priority Data
Jan. 5, 2023 (DE) 102023200082.2

(51) Int. Cl. G06N 3/067; B23K 26/03

(52) U.S. Cl. CPC G06N 3/0675; B23K 26/032

(57) ABSTRACT

Embodiments according to the present invention include an optical apparatus for providing optical real-time information regarding a process, wherein the optical apparatus is configured to detect an optical input signal that is radiated and/or reflected by the process and wherein the optical apparatus comprises an optical neural network that is configured to provide the optical real-time information regarding the process based on the optical input signal.

Further, a system for providing optical real-time information and a method for providing the apparatus are disclosed.

### CROSS-REFERENCE TO RELATED APPLICATIONS

This application is a continuation of copending International Application No. PCT/EP2024/050127, filed Jan. 4, 2024, which is incorporated herein by reference in its entirety, and additionally claims priority from German Application No. 10 2023 200 082.2, filed Jan. 5, 2023, which is also incorporated herein by reference in its entirety.

Embodiments according to the present invention relate to apparatuses and systems for providing optical real-time information regarding a process by means of an optical neural network as well as to methods for providing such apparatuses.

Further, embodiments include optical process monitoring with diffractive neural networks, optical process monitoring with diffractive deep neural networks and/or optical image processing with diffractive deep neural networks.

### BACKGROUND OF THE INVENTION

In laser material processing and laser measurement technology, systems are used that monitor the state of the process during processing. This process monitoring is frequently based on a system consisting of illumination, monitoring optics and a detector (CCD chip). On the detector, an image of the process zone is generated, which will be evaluated in the connected computer by image processing methods. Based on this evaluation, the quality of the process can be inferred and the processing process can be regulated. In modern approaches of process monitoring, neural networks are used to process the image data (in line) and to adapt the process parameters. So far, this is exclusively performed in the electronic computing unit controlling the processing plant.

Those and very similar approaches can also be found in patents or utility models or respective applications (for example, U.S. Pat. No. 65,974,491, CN000216680796U, U.S. Pat. No. 5,517,420A, CA2467221A1, CN000201052570Y). The disadvantages of the conventional technology are, among others, the latency time (duration between data acquisition and output of the control parameters) and the needed hardware for image processing (frequently high-performance computers with Multi GPU). The hardware is expensive, large (server racks) and has a high energy consumption during operation. The energy consumption can be obstructive for some mobile applications. With the number of used sensors, the needed resources for the high-performance computer are scaled.

### SUMMARY

An embodiment may have an optical apparatus for providing optical real-time information regarding a process; wherein the optical apparatus is configured to detect an optical input signal that is radiated and/or reflected by the process; wherein the optical apparatus includes an optical neural network that is configured to provide the optical real-time information regarding the process based on the optical input signal; wherein the process is a controlled and/or regulated process; and wherein the optical neural network is configured to determine, based on the optical input signal, a control signal and/or a regulation signal and to encode the control signal and/or the regulation signal into the optical real-time information.

According to another embodiment, an optical system may have: an inventive optical apparatus; a detector configured to detect the optical real-time information and to provide an electric signal based on the optical real-time information; wherein the detector includes at least one of a photo diode, a line detector, and/or an area detector.

Another embodiment relates to a method for providing an optical apparatus, wherein the optical apparatus includes an optical neural network configured to provide optical real-time information regarding the process based on an optical input signal that is radiated and/or reflected by a process; wherein the optical neural network includes at least one first optical element and at least one adaptable optical element; wherein the method includes: simulative pre-training of a virtual model of the optical neural network with a first set of training data, wherein the at least one first optical element and the at least one adaptable optical element are mapped in the virtual model; and generating the optical neural network based on the pre-trained model; adapting the at least one adaptable optical element in the virtual pre-trained model of the optical neural network based on a simulative training of the virtual pre-trained model with a second set of training data; and adapting the at least one adaptable optical element of the optical neural network in accordance with the adapted virtual model of the optical neural network to provide the optical apparatus.

Another embodiment may have an optical apparatus for providing optical real-time information regarding a process; wherein the process is a material processing process and/or a measurement process by using a laser where a workpiece is measured or processed; wherein the optical apparatus is configured to detect an optical input signal that is radiated and/or reflected by the process; and wherein the optical apparatus includes an optical neural network that is configured to provide the optical real-time information regarding the process based on the optical input signal.

Another embodiment may have an optical apparatus for providing optical real-time information regarding a process; wherein the process is a material processing process and/or a measurement process by using a laser; and wherein the optical apparatus is configured to detect an optical input signal that is radiated and/or reflected by the process; and wherein the optical apparatus includes an optical neural network that is configured to provide the optical real-time information regarding the process based on the optical input signal; wherein the optical apparatus is configured to capture the optical input signal immediately before the process for detecting the optical input signal that is radiated and/or reflected by the process.

Another embodiment may have an optical apparatus for providing optical real-time information regarding a process; wherein the process is a material processing process and/or a measurement process using a laser; and wherein the optical apparatus is configured to detect an optical input signal that is radiated and/or reflected by the process; and wherein the optical apparatus includes an optical neural network that is configured to provide the optical real-time information regarding the process based on the optical input signal; wherein the process includes beam forming of a process beam by means of processing optics; and wherein the processing optics is configured to form the process beam and guide the same to a workpiece; wherein the optical apparatus includes a beam splitter; wherein the beam splitter is configured to obtain the optical input signal in the form of radiation that is radiated and/or reflected by the workpiece via the processing optics and/or via individual optical partial elements of the processing optics; and wherein the optical apparatus is configured to separate the optical input signal from the process beam by means of the beam splitter; and wherein the optical apparatus is configured to provide the optical input signal to the optical neural network by means of the beam splitter.

Another embodiment may have an optical apparatus for providing optical real-time information regarding a process; wherein the optical apparatus is configured to detect an optical input signal that is radiated and/or reflected by the process; wherein the optical apparatus includes an optical neural network that is configured to provide the optical real-time information regarding the process based on the optical input signal; wherein the process includes beam-forming of a process beam by means of processing optics; and wherein the optical apparatus is configured to obtain the optical input signal via the processing optics and/or via individual optical partial elements of the processing optics; and wherein the optical neural network is configured to evaluate the optical input signal directly in the processing optics, and to output an intensity pattern into which the results of the evaluation or new control and/or regulation signals for the process are encoded.

Embodiments according to the present invention include an optical apparatus for providing optical real-time information regarding a process, wherein the optical apparatus is configured to detect an optical input signal that is radiated and/or reflected by the process and wherein the optical apparatus comprises an optical neural network that is configured to provide the optical real-time information regarding the process based on the optical input signal.

Embodiments are based on the idea of performing process evaluation by means of an optical neural network. Generally, the optical neural network can be, for example, a diffractive neural network. A diffractive neural network can comprise, for example, a sequence of several diffractive elements that are configured to modulate radiation, i.e., for example the optical input signal or an optical signal derived therefrom, in phase and amplitude. The inventors have found that process evaluation can take place in real time by means of an optical neural network, such that the apparatus can provide real-time information on the process.

Here, real-time information means, for example, information whose generation is performed at the speed of light from detection to provision, i.e., a delay of the travelled path from the location of the radiation of the optical input signal at the process to a radiation location of the real-time information at the apparatus results based on the speed of light. Therefore, real-time information can be information whose provision or processing is merely limited by the speed of light.

Further, the inventors have found out that this can result in significant energy savings. Respective process evaluation can take place in a completely optical manner by means of the optical neural network, such that no energy has to be provided for electronic evaluation. Alternatively, for example, only a particularly computing-intensive part of the evaluation can be performed in an optical manner. Optionally, any part of the evaluation can be performed in an optical manner. In any case, energy can be saved in comparison to electronic evaluation, such that, for example, also mobile process monitoring becomes possible.

Here, it will be noted that, for example regarding production machines, high mobility might possibly or even normally be less relevant, but embodiments can still have the advantage that the same can be designed in a very compact manner, for example with little volume and/or can allow a compact, e.g., spatially small configuration of such a production machine. Further, according to embodiments, no (large, for example powerful) high-performance computer at the machine or access to cloud computing with respective infrastructure is needed.

Further, costs for process monitoring can be saved, as less powerful computing units can be used for electronic evaluation due to the possible optical preprocessing.

The optical input signal can be, for example, a signal that is radiated and/or reflected by the process. Thus, evaluation can take place, for example, merely based on light generated by the process itself. Alternatively, light generated independent of the process, for example ambient light or a light of a specifically provided light source, can be reflected by a process, for example a workpiece that is measured or processed, and can serve as input signal.

The process can, for example, be a processing and/or measuring of a workpiece (e.g., a material processing process of the workpiece and/or a measurement process at the workpiece by using a laser), where a signal radiated or reflected by the workpiece is used as optical input signal.

In particular, the optical apparatus can be configured, for example, to immediately use such radiation emitted or reflected by the workpiece, i.e., for example without any further electronic capturing or rendering.

In other words, the input signal can be provided, for example, with process light (e.g., thermal radiation), with ambient light and/or with a specific external illumination (for example coherent illumination and/or structured illumination).

Here, embodiments can be used, for example, for general process monitoring or measurement technology (e.g., water jet cutting, tape placement with IR radiation, . . . ) and in particular for process monitoring or measurement technology in laser-based methods (e.g., laser beam welding, drilling, additive manufacturing, LIBS, laser triangulation . . . ). As discussed above, it is an inventive idea to use optical neural networks for process monitoring, for example in the above-stated fields of application.

In particular, specific embodiments include a novel component and method for detecting and evaluating process images. Here, a diffractive neural network (DNN or generally an optical neural network) can be used to evaluate the light coming from the process zone (i.e., radiated and/or reflected light) directly in the processing optics and to output an intensity pattern (for example, instead of or in addition to 2D image data), into which the results of the evaluation or new control and/or regulation signals can be encoded. Compared to conventional methods (e.g., evaluation in an electronic computing unit), embodiments have the advantage that data processing takes place at the speed of light. This is based on the finding of the inventors that the duration of image processing, derivation of the quality features and the new control signals is decisive for the speed of regulation. Thus, the image analysis can practically be available instantaneously for the regulation unit. Thus, embodiments can circumvent or shorten the longer computing times in the computer (e.g., in the case of electronic further processing of the real-time information).

According to embodiments, the optical apparatus is further configured to capture the optical input signal immediately before the process for detecting the optical input signal that is radiated and/or reflected by the process.

For example, the apparatus can be integrated directly in elements close to the process, for example in contrast to an “external” evaluation of an electronically detected image at a computer remote to the process. For example, the optical apparatus or also parts of the optical apparatus, such as the optical neural network, can be integrated in the processing optics of a respective process.

Thus, the input signal can be obtained directly by the process, for example without forwarding by means of a waveguide. For example, the optical apparatus can be configured to be arranged on the same fluid in which the process is performed in order to capture the optical input signal immediately from the fluid.

The inventors have found that an inventive optical apparatus needs only little installation space and can therefore be integrated into elements needed for the process (i.e., simply put, elements that are already present). Thus, on the one hand, space can be saved and, on the other hand, an influence of possible error sources due to signal transmissions (for example signal losses in electric line, electromagnetic interferences on the line) can be prevented or reduced.

Further, according to embodiments, the optical apparatus comprises optical means configured to obtain the optical input signal and to provide, based on the input signal, an optical signal for determining the real-time information to the optical neural network. Optionally, the optical means can include at least one of a lens, a beam splitter, a mirror, a wavelength filter and/or an aperture.

The inventors have found that the optical input signal can be rendered for the optical neural network by means of optical means, for example to allow an improved classification result. Further, the usage of optical elements allows a degree of freedom when integrating the optical apparatus, as the optical input signal can be guided to an advantageous installation location of the optical apparatus (for example by means of mirrors).

According to embodiments, the process includes beam-forming of a process beam by means of processing optics and the optical apparatus is configured to obtain the optical input signal via the processing optics and/or via individual optical partial elements of the processing optics.

Here, inventive processes are not limited to specific processes and respective process beams. The process beam can be, for example, a laser beam or an electron beam (E beam). Here, the processing optics can include any combinations of optical elements, for example one or several optical mirrors, lenses and/or prisms.

Further, it should be noted that the processing optics or parts thereof can also act as optical means or can be used as such.

The inventors have found that processing optics or also individual optical partial elements of such optics can be shared by both the process and for process monitoring. Thereby, devices and installation space can be saved.

According to embodiments, the optical apparatus comprises a beam splitter, wherein the beam splitter is configured to obtain the optical input signal via the processing optics and/or via individual optical partial elements of the processing optics. Further, the optical apparatus is configured to separate the optical input signal from the process beam by means of the beam splitter, and to provide the optical input signal to the optical neural network by means of the beam splitter. Splitting the beams can include, for example, forwarding in different directions.

The inventors have found that thereby, for example, coaxial process monitoring is enabled. A respective processing optics can form the process beam and guide the same to a workpiece, wherein the radiation emitted and/or reflected by the workpiece can be guided as optical input signal through the same processing optics (or at least same parts thereof), wherein an optical path can be adapted by means of the beam splitter such that the optical input signal is provided to the optical neural network and is, for example, not guided into an area where the process beam is generated.

Specifically, for example in a so-called coaxial process monitoring, the sensor technology, for example an inventive apparatus, can be integrated directly into the processing head, which at the same time influences the processing laser. The trick is here that both beams (the process beam, for example a processing laser beam as well as the optical input signal, for example a measuring beam from the process zone) partly pass through the same optical elements and are separated remote from the process zone via the (or several) beam splitter. Thus, according to the invention, both parts (sensor technology and application) can cooperate. This enables efficient component integration.

According to embodiments, the optical neural network comprises at least one of a diffractive optical element, a spatial light modulator and/or meta optics. For example, a configuration for an inventive optical apparatus and/or the optical neural network (ONN) can include a free combination of at least two diffractive optical elements (DOE) and/or spatial light modulators (SLM) (or one each or for example merely the one or the other, or merely several DOE or merely several SLM), classical optical components (e.g., lenses, mirrors, apertures, wavelength filters, etc.) and/or classical (computer-based) Al methods (ONN replaces, for example some computing-intensive levels).

According to embodiments, the process is a controlled and/or regulated process and the optical neural network is configured to determine, based on the optical input signal, a control signal and/or a regulation signal and to encode the control signal and/or the regulation signal into the optical real-time information.

In that way, control and/or regulation information can be provided in real time. In particular, controls and/or regulations for very fast processes can be enabled, i.e., with high requirements regarding recovery times. A respective regulation can for example take place completely analogously, for example based on a detection of the encoded information without AD conversion. Here, for example, an amplitude or phase of the detection signal can be use directly for regulation and/or control.

According to embodiments, the optical neural network is configured to determine a process parameter based on the optical input signal and to encode the process parameter into the optical real-time information.

Here, a process parameter is, for example a quantity relevant for the process. In the context of processing a workpiece, a process parameter can describe, for example the quality of a processed workpiece. Further, a measurement results by means of a process beam can also form a process parameter. Thus, for example, in a light cutting method, a laser can provide the process beam that is reflected by a surface, such that the reflected signal forms the optical input signal. Here, the process parameter can include, for example, information on a height measurement value. The inventors have found that according to the invention, process evaluations can be provided at high speed with little energy expenditure.

Here, it should be noted that the process according to embodiments does not always have to be controlled or regulated. Embodiments include and/or address in particular applications where quality features (as an example of process parameters) are “only” monitored, for example. This can, for example, be the formation of splatters or errors in the weld seam. Accordingly, respective information can be encoded into the optical real-time information.

According to embodiments, the optical apparatus is configured to modify a phase and/amplitude of the optical input signal to provide the optical real-time information in the form of a light point, a line beam and/or a two-dimensional light array.

Providing the real-time information as light point allows a representation of the information that is easy to evaluate. By means of a line beam, for example, by a centroid of the line, a scalar value can be illustrated as process parameter or regulation and/or control information (e.g., in the interval [0,1], such that, for example, a centroid on one side of the line corresponds to zero and on an opposite side to one, with respective intermediate values). By means of a two-dimensional light array, accordingly, two-dimensional information can be illustrated, encoding can take place, for example, by means of patterns or centroids.

It should be noted that an optical input signal, for example in the form of an input light field can also comprise only exactly one phase and amplitude, such that the apparatus can be configured to modify the phase and/or amplitude of the optical input signal. Further, with embodiments, also input signals can be addressed or processed that have a partial coherence by several overlapping fields with different phases.

According to embodiments, the optical neural network comprises at least one static optical element and at least one adaptable optical element and the adaptable optical element is configured to change the processing of the optical input signal in the optical neural network.

Thus, for example, method of transfer learning can be used, wherein the statical elements are generated according to a generic pre-training, for example, and the dynamical elements are adapted in an application specific manner with respect to a second training. Further, in that way, readjustments can be performed during the live span of the apparatus.

According to embodiments, the optical apparatus further comprises an optical filter that is configured to filter the optical input signal in a wavelength-selective manner to provide a filtered optical input signal to the optical neural network.

In that way, for example wavelengths allowing a particularly significant process analysis can be selected.

According to embodiments, the optical apparatus further comprises a light source, wherein the light source is configured to illuminate the process to generate the optical input signal that is radiated and/or reflected by the process. Such a light source can, for example, be also integrated in the process elements in a coaxial manner.

According to embodiments, the optical neural network is configured to process light with a specific optical property and the light source is configured to provide the light with the specific optical property.

In other words, for example the light source and optical neural network can be tuned to each other. The optical property can be a specific wavelength. In that way, accuracy and/or efficiency of the neural network can be improved.

According to embodiments, the optical apparatus comprises a beam splitter, the beam splitter or a further beam splitter and the optical apparatus is configured to separate the light of the light source from the optical input signal by means of the beam splitter or the further beam splitter and to provide the optical input signal to the optical neural network by means of the beam splitter or the further beam splitter.

As discussed before in the context of the processing optics, integration, e.g., in a coaxial manner, of light source and optical neural network can also take place together with a process beam source, such as in a processing head or a processing optics.

It should be noted that according to embodiments, with respect to the illumination (or the illumination range), wavelengths between 10 μm (thermal radiation) to 400 nm (visible light) can be used. As explained above, external illumination (e.g., by means of the light source) can take place in a coaxial manner.

An advantage of embodiments in wavelength ranges above UV (ultraviolet) light (i.e. for example for a wavelength of more than 400 nm) can be, for example, in a simple or for example simpler production of the optical elements (e.g. DOE and/or SLM) for the optical neural network.

According to embodiments, the optical apparatus is configured to be supplied with energy for providing the optical real-time information exclusively by means of the optical input signal. In that way, mobile applications and applications with high requirements regarding energy consumption can be addressed.

Further, embodiments of the present invention include an optical system including an optical apparatus according to any of the embodiments disclosed herein and the detector (e.g. CCD chip) configured to detect the optical real-time information and to provide an electric signal based on the optical real-time information, wherein the detector includes at least one of a photodiode, a line detector and/or an area detector.

In that way, a processed or pre-processed electric signal can be provided at high speed due to the optical processing in the optical neural network.

Further, according to embodiments, the optical system comprises a processing means configured to control and/or regulate the process based on the electric signal of the detector and/or to provide information regarding the process based on the electric signal of the detector.

Here, the processing means can work, for example, in a digital manner or for very fast regulation circuits, in an analog manner. The control and/or regulation of the process can in particular include control and/or regulation of a process plant. For example, a plant including a laser can be regulated and/or controlled. The control and/or regulation can include, for example, adaptation of a feed speed, material supply and/or adaptation of or with respect to process gasses.

According to embodiments, the process is a material processing process and/or a measurement process (e.g. laser measurement process, e.g. laser induced plasma spectroscopy, LIBS) by using a laser and the processing means is configured to control and/or regulate the laser based on the electric signal of the detector. Further, for example, other parameters can be controlled and/or regulated in a machine of the process (for example, a machine including the laser), e.g., axes, scanners, protection gas supply.

Further, embodiments according to the present invention include methods for providing an optical apparatus (for example one of the above discussed optical apparatuses), wherein the optical apparatus comprises an optical neural network that is configured to provide optical real-time information regarding the process based on an optical input signal that is radiated and/or reflected by a process. Here, the optical neural network comprises at least one first optical element and at least one adaptable optical element.

Here, the method includes simulative pre-training of a virtual model of the optical neural network with a first set of training data, wherein at least one first optical element and the at least one adaptable optical element are mapped in the virtual model.

Further, the method includes generating the optical neural network based on the pre-trained model, adapting the at least one adaptable optical element in the virtual pre-trained model of the optical neural network based on a simulative training of the virtual pre-trained model with a second set of training data and adapting the at least one adaptable optical element of the optical neural network according to the adapted virtual model of the optical neural network to provide the optical apparatus.

The inventors have found that methods of transfer learning can be applied to optical neural networks by means of using adaptable optical elements. For example, generic pre-training can be considered, for example, by means of at least one first optical element, such that an application-specific “fine-training” can be mapped by means of the adaptable elements. Here, the training can be performed efficiently in a computer-aided manner.

Here, it should be noted that, according to embodiments, the training can be performed by using images merely at the computer without the usage of adaptable or dynamic elements. In that way, conventional training methods can also be used for training (from applications in image recognition).

Further, it should be noted that generally according to embodiments, the at least one first optical element and the at least one adaptable optical element can be arranged in any order in the optical neural network. Along an optical path, starting from the process, the at least one first optical element can be arranged, for example before or after the at least one adaptable optical element. The adaptable optical element can form, for example, a foremost or rearmost optical element of the optical neural network. Thus, for example, the first (e.g. in the sense of the foremost regarding an optical path starting from the process) optical element can be adaptable and all optical element behind the same can be static. Vice versa, for example, the foremost optical elements can be static and merely the rearmost optical element can be adaptable or dynamic.

According to embodiments, the at least one first optical element is a static or adaptable (for example dynamic) optical element. Thus, arrangements with merely adaptable optical elements are possible.

According to embodiments, the method further comprises generating the first and/or second set of training data by using a camera capturing the optical input signal via an optical means and using the optical means to provide an optical signal for determining the real-time information to the optical neural network based on the optical input signal.

The inventors have found that-simply put-double usage of such optical means can allow improved training efficiency, as both the training data and the optical input signal can be provided by the same optical means. Thus, errors due to deviating optical properties (e.g. component tolerances) when using two different optical means can be counter acted. It should be noted that the optical means can also be formed by a partial element of processing optics.

### BRIEF DESCRIPTION OF THE DRAWINGS

Regarding the illustrated schematic figures it should be noted that the illustrated functional blocks can be considered both as elements or features of the inventive apparatus as well as respective method steps of the method according to the disclosure and respective method steps of the method according to the disclosure can be derived therefrom. Embodiments of the present invention will be detailed subsequently referring to the appended drawings, in which:

FIG. 1 is a schematic illustration of an optical apparatus for providing optical real-time information regarding a process according to embodiments of the present invention;

FIG. 2 is a schematic illustration of an optical apparatus comprising additional optional features according to embodiments of the present invention;

FIGS. 3A-C are schematic views of embodiments according to the present invention, wherein the process includes beam forming of a process beam by means of processing optics;

FIG. 4 is a schematic view of a system according to embodiments of the present invention;

FIG. 5 is a schematic view of an optical apparatus according to embodiments with an adaptable optical element;

FIG. 6 is a schematic block diagram of an inventive method for providing an optical apparatus; and

FIG. 7 is a schematic view of a system according to embodiments with further optional features.

### DETAILED DESCRIPTION OF THE INVENTION

Before embodiments of the present invention will be discussed in more detail below based on the drawings, it should be noted that identical, functionally equal or equal elements, objects and/or structures in the different figures are provided with the same or similar reference numbers, such that the description of these elements illustrated in different embodiments is inter-exchangeable or inter-applicable.

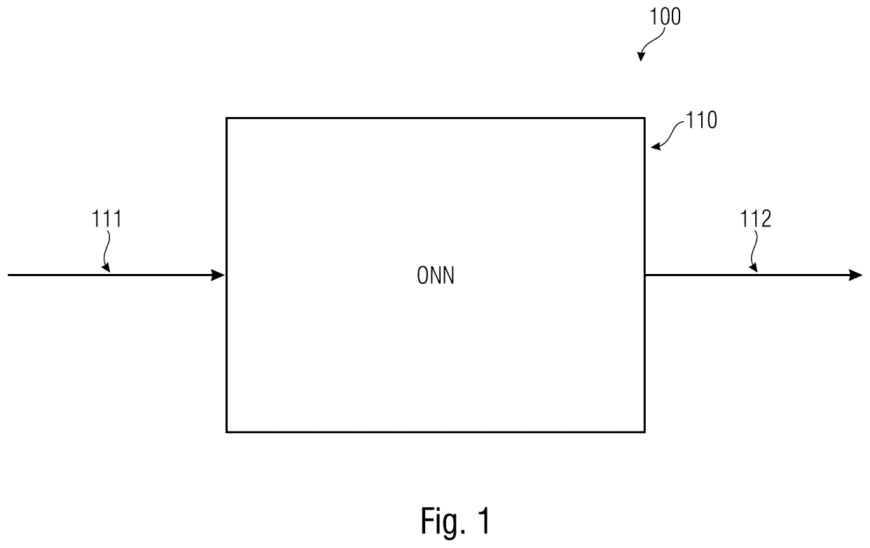

FIG. 1 shows a schematic illustration of an optical apparatus for providing optical real-time information regarding a process according to embodiments of the present invention. The optical apparatus 100 includes an optical neural network 110.

The optical input signal 101 can be radiated, for example, (e.g. in the case of thermal emission) and/or reflected (e.g. in the case of processing or measuring a workpiece with a laser, wherein laser radiation is reflected away from the workpiece) by a process.

Accordingly, the optical apparatus 100 is configured to detect the optical input signal. The optical neural network 110 is configured to provide optical real-time information 112 regarding the process based on the optical input signal.

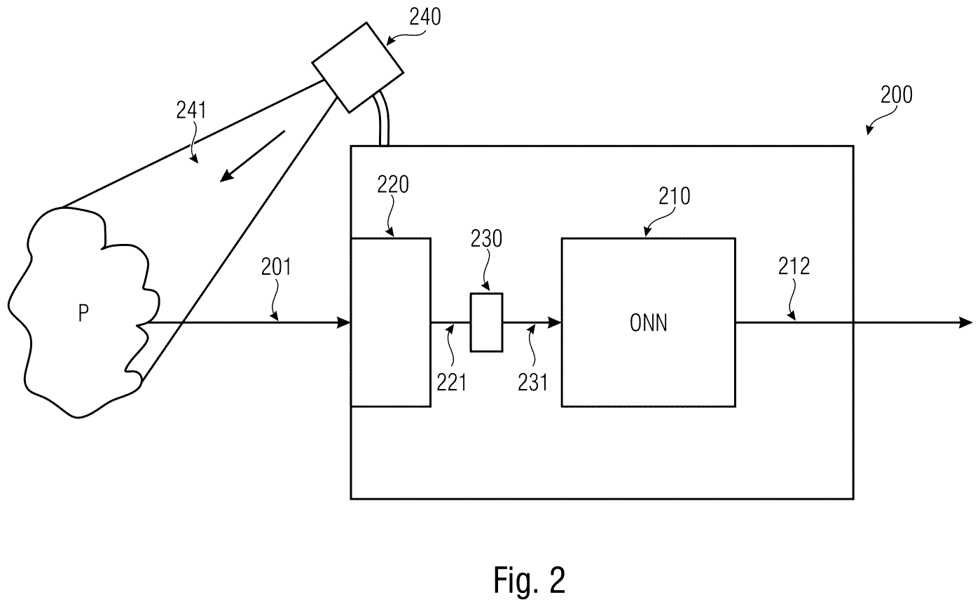

FIG. 2 shows a schematic illustration of an optical apparatus with additional optional features according to embodiments of the present invention. FIG. 2 shows an apparatus 200 including an optical neural network 210, an optional filter 220, optional optical means 230 as well as an optional light source 240. As discussed based on FIG. 1, the optical neural network 210 is configured to provide optical real-time information 212 regarding process P.

As shown in FIG. 2, the optical apparatus 200 can optionally be configured to capture the optical input signal immediately from the process for detecting the optical input signal 210 that is radiated and/or reflected by the process P.

FIG. 2 shows an example of an embodiment where the filter 220 is arranged in front of (signal path starting from process P) the optical means 230. According to embodiments, the optical means 230 can also be arranged after the filter 220. The filter 220 is configured, for example, to filter the optical input signal 201 that is radiated and/or reflected by the process P, for example, in a wavelength-selective manner. In that way, wavelengths contributing only little or nothing to a process classification can be filtered out.

For example, for processes that do not radiate any or insufficient radiation (for determining real-time information), an inventive apparatus 200 can comprise a light source 240. By means of the light source, the process can be illuminated or irradiated, such that light 241 can cause a reflected signal 201 which can form the input signal. Here, however, it should be noted that a respective input signal 201 can also include a superposition of process radiation, such as thermal radiation, and reflected radiation of an illumination 240, or also reflected radiation of a process beam, such as a processing laser. Obviously, the light source can also be used for processes that emit radiation themselves, for example to add information in a different wavelength range to the input signal.

Optionally, the optical diffractive neural network 210 can be, for example, configured to process light with a specific optical property, for example a specific wavelength, and accordingly, the light source can be configured to provide light with exactly that determined optical property (e.g. also wavelength range). Accordingly, the filter can be configured to transmit only light with the specific optical property.

Here, again, an advantage of using the filter 220 can be that a simple, for example inexpensive light source 240 having a broad spectrum can be used, wherein the filter can filter out wavelengths that are irrelevant or carry only little information for the process classification.

Thus, a filtered input signal 221 is provided to the optical means 230. Again, the optical means is configured to obtain the input signal 201, for example in further processed form of the filtered input signal 221 to supply the same as optical signal 231 to the optical neural network 210.

The optical means can include, for example, at least one of a lens, a beam splitter, a mirror and/or an aperture. The optical neural network can further include, for example, at least one of a diffractive optical element, a spatial light modulator and/or meta optics.

Here, the optical real-time information can be provided, for example, in the form of a light point, a line beam and/or a two-dimensional light array, or include such forms of representation. For this, the optical neural network 210 can be configured to modify a phase and/or amplitude of the optical input signal, i.e. in particular optionally of the optical signal 231 and/or the filtered input signal 221.

For example, without any light source 240, an optical apparatus 200 can optionally only be supplied with energy exclusively by means of the optical input signal 201 for providing the optical real-time information 212.

As a further optional feature, in the real-time information 212, a control signal and/or a regulation signal can be provided, which is determined by the optical neural network 210. Thereby, for example process P can be controlled and/or regulated. Alternatively or additionally, a process parameter determined by the optical neural network 210 can be encoded into the optical real-time information 212.

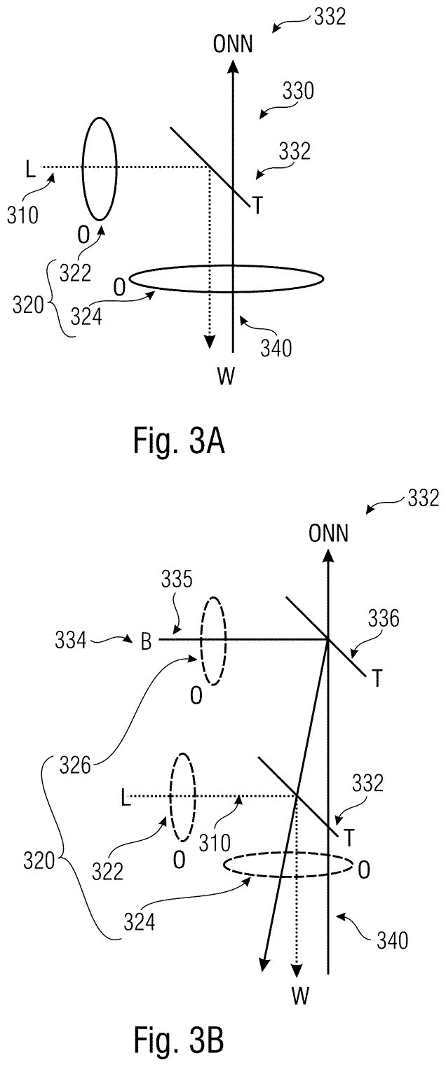

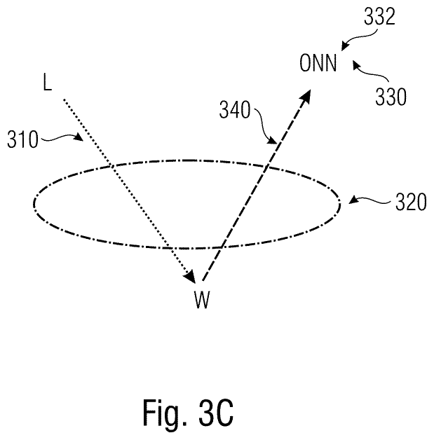

FIGS. 3A-C show schematic views of embodiments according to the present invention, wherein the process includes beamforming of a process beam by means of processing optics. FIGS. 3A-C show optical neural networks ONN, process beam sources L, optical partial elements O, beam splitters T, light source B as well as workpieces W. The process beam source can, for example, be a laser.

FIG. 3A shows a schematic view of a, for example, typical coaxial structure according to embodiments. A process beam is formed by means of processing optics 320 including a first optical partial element 322 and a second optical partial element 324, and guided to a workpiece W.

Here, the optical apparatus 330 including the optical neural network ONN 332 is configured to obtain the optical input signal 340 via the optical partial element 324 of the processing optics 320. For this, the apparatus 330 comprises a beam splitter T, 332 as an additional optional feature. Here, the beam splitter 350 is configured to separate the process beam 310 from the reflected input signal 340 to provide the optical input signal to the optical neural network.

Such an arrangement allows coaxial integration of the optical apparatus into a processing optics of the process. It should be noted that the processing optics can also include only one optical partial element. The optical partial elements can be, for example, classical optical devices, such as lenses, apertures or also protective glasses. It should again be noted that the processing optics or partial elements thereof can serve as optical means of the apparatus.

FIG. 3B shows a schematic view of a further structure according to embodiments, wherein the apparatus 300 comprises an optional light source 334 as well as a further beam splitter 336. As explained above, the light source 334 is configured to illuminate the process in order to generate the optical input signal 340 that is radiated and/or reflected by the process.

It should be noted that generally, according to embodiments, the input signal can comprise both, light radiated by the process itself as well as light generated and reflected by the light source. Then, the light source 334 generates the input signal 340 in that the portion of the input signal that is not radiated by the process itself is provided.

By means of the beam splitter 332, as shown in FIG. 3B, the process beam 310 can be separated or split from the optical input signal. By means of the beam splitter 336, again, the light 335 of the light source 334 can be separated from the optical input signal, such that the workpiece W is illuminated and the optical input signal 340 can be provided to the optical neural network 332.

FIG. 3B shows a schematic view according to a structure according to embodiments wherein, apart from the process beam, i.e. for example processing or measurement beam, also the optionally existing additional illumination can be integrated in a coaxial manner.

It should be noted that according to embodiments only one of the beam splitters can be provided. In other words, illumination with a beam splitter cannot only be used in combination with the beam splitter for the process beam. Further, the beam splitter, for example having several optical partial elements, can separate both the process beam as well as the light of the light source from the optical input signal.

Further, it should be noted that the processing optics, for example an illumination optics by which the processing beam can be formed, does not necessarily have to consist of only one element. According to embodiments, several lenses, mirrors and further individual optics can be combined to obtain the desired beamforming. Thus, it can be the case that only part of the elements of the processing optics is relevant for the ONN measurement beam, for example 340.

FIG. 3C shows a schematic view of a further structure according to embodiments, wherein the process includes beamforming of a process beam by means of processing optics 320 (which can again comprise, for example, several partial elements) and wherein the optical apparatus 320 is configured to obtain the optical input signal 320 via the processing optics.

One advantage of the arrangements according to FIG. 3A and 3B compared to an arrangement 3C can, for example, be that smaller optical members can be used for the processing optics.

However, an arrangement according to FIG. 3C can address, for example, a special case, wherein both beams are guided through a protective glass, which is arranged behind the last beamforming element in the optical path and separates, for example, the process zone from the environment and prevents contamination. A respective protective glass can also form an optical element or optical partial element of a processing optics or an optical means.

The arrangements according to FIGS. 3A-C allow the detection of a feedback from the process and/or member without optical elements of the neural network, for example spatial light modulators at high power as normally needed in the material processing process, can be destroyed.

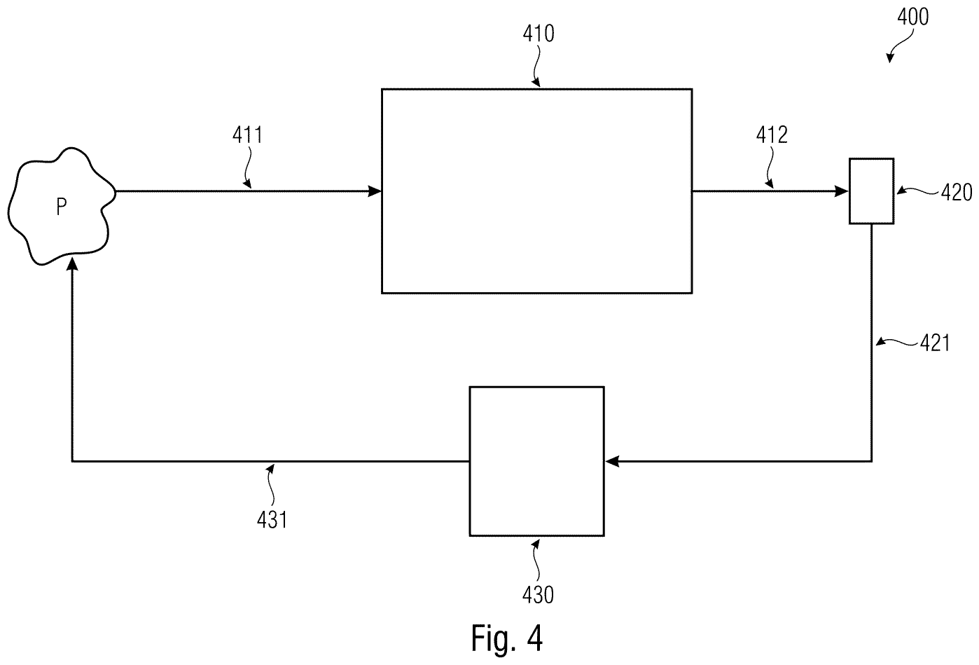

FIG. 4 shows a schematic view of a system according to embodiments of the present invention. The system 400 includes an optical apparatus 410, as well as a detector 420 that is configured to detect the optical real-time information 412 and to provide an electric signal 421 based on the optical real-time information. The optical input signal of process P is indicated by reference number 411.

The apparatus 410 can, in particular, comprise the above-discussed optional features, both individually and in combination.

As a further optional feature, the system 400 includes processing means 430 that is configured to control and/or regulate the process P based on the electric signal 421 of the detector 420. For this, an actuator 431 is shown as an optional feature in process P. Alternatively or additionally, the processing means 430 can be configured to provide information regarding the process based on the electric signal of the detector. Here, for example, the actuator 431 can be omitted and instead the information regarding the process can be provided by the processing means 430.

Specifically, the process can be, for example, a material processing process and/or a measurement process using a laser, wherein the processing means 430 can accordingly be configured to control and/or regulate the laser based on the electric signal 421 of the detector.

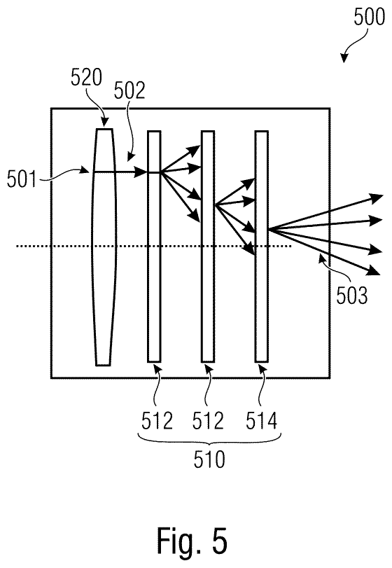

FIG. 5 shows a schematic view of an optical apparatus according to embodiments with an adaptable optical element. The apparatus 500 includes an optical neural network 510, as well as, as a further optional feature, optical means 520. The optical means is configured to provide an optical signal 510 for the optical neural network 510 based on the optical input signal 510, wherein the optical neural network 510 is again configured to provide the real-time information 503.

As an optional feature, the optical diffractive neural network includes at least one static optical element 512 and at least one adaptable optical element 514. Here, the adaptable optical element is configured to change the processing of the optical input signal 501 in the optical diffractive neural network. In other words, the adaptable optical element can be an adjustable or, for example, dynamic optical element which can be changed.

In the following, an inventive method for providing an optical apparatus, for example an apparatus 500 (see FIG. 5, optionally without optical means 520) will be discussed.

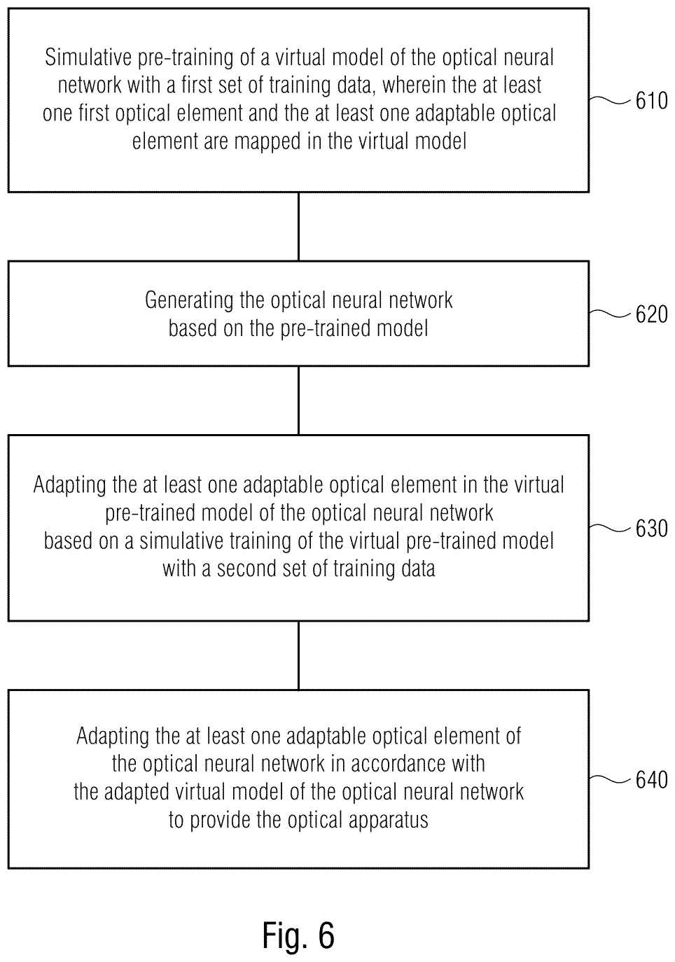

FIG. 6 shows a schematic block diagram of such an inventive method for providing an optical apparatus, wherein the optical apparatus, e.g. 500 comprises an optical neural network, e.g. 510, that is configured to provide optical real-time information, e.g. 503, regarding the process based on an optical input signal, e.g. 501, that is radiated and/or reflected by a process, wherein the optical neural network comprises at least one first optical element, e.g. 512, and at least one adaptable optical element, e.g. 514.

Here, the method 600 includes simulative pre-training 610 of a virtual model of the optical neural network with a first set of training data, wherein the at least one first optical element, e.g. 512, and the at least one adaptable optical element, e.g. 514 are mapped in the virtual model. Further, the method 600 includes generating the optical neural network, e.g. 510, based on a pre-trained model, adapting the at least one adaptable optical element in the virtual pre-trained model of the optical neural network based on a simulative training of the virtual pre-trained model with a second set of training data and adapting the at least one adaptable optical element, e.g. 514, of the optical neural network according to the adapted virtual model of the optical neural network to provide the optical apparatus, e.g. 500.

Here, the one or several first optical elements, e.g. 512 of FIG. 500 can optionally be static or adaptable, i.e. can be, for example dynamic optical elements. Here, a combination of static and adaptable elements is also possible.

According to embodiments, part of the optical elements of the optical neural network can be adjusted based on a first training, for example fixed, or, for example by means of static optical elements, and a second part of the optical elements of the network that are adaptable and/or adjustable can be readjusted based on a second training. In that way, for example, methods of transfer learning can be applied.

Here, it should be noted again that the training, according to embodiments, can be performed merely at the computer by using images, and an inventive arrangement might not comprise or need any dynamic elements. Thus, also known training methods (for example for applications in image recognition) can be used for providing an inventive apparatus.

Further, establishing the first and/or second set of training data can optionally take place by using the same optical means. The inventors have found that a training quality can be improved when the training data are generated with the same optical means that is used for providing the optical signal from the optical input signal for the neural network.

In that way, mapping errors, for example when using different optics for generating the training data compared to the “field usage” of the optical apparatus, can be prevented or reduced.

An exemplary course of an inventive training of an ONN can, for example, include the following:
1. Optional set-up of the external illumination, when needed/advantageous
2. E.g., taking classical camera pictures for training data. Depending on the process requirements, the camera can only be used as a sensor, but also with an objective or in a coaxial optical path by the processing optics. This objective can then subsequently optionally remain in the structure (for example as optical means of the optical apparatus) or the integration of the ONN could optionally also take place in a coaxial manner.
3. Labeling, for example classification of the (e.g. electronic) training data: for example for simple features, such as the size of the melting bath, this can optionally take place in an automated manner, e.g., by established image processing methods, for example for more complex data, this can take place manually. Training data can optionally be scaled artificially, for example by mirroring/rotations, when needed.
4. Training of an ONN with the labeled training data at the computer: complexity of the ONN can, for example, be decided based upon the complexity of the task. A pre-trained ONN, for example on the image-net data set, can be used with transfer learning to merely map the last, for example 1-2, levels by adaptable optical elements, for example SLM (that can be or even have to be newly trained)
   advantage of fast adaptation in serial production
5. Production of the needed first optical elements, for example DOE, (e.g., externally, for example by means of known methods from conventional technology) and optionally, complete integration of the system (for example with additional optical components, e.g., in dependence on further application properties) in the process structure, e.g., in a coaxial manner.

In the following, embodiments will be discussed again in other words, for example, with further optional features, and further embodiments will be discussed.

Embodiments are not limited to process monitoring in laser material processing. Generally, image data from production processes or other fields (e.g., face recognition, environmental analysis, autonomous driving, . . . ) can be evaluated extremely fast by compact sensor technology.

For this, embodiments include a novel component and method for detecting and evaluating process images. Here, an optical neural network, for example in the form of a diffractive neural network (DNN), is used in order to evaluate the light coming from the process zone, for example directly in the processing optics, and in that way (for example instead of 2D image data) to output an intensity pattern into which the results of the evaluation or new control signals can be encoded. Compared to conventional methods (e.g., evaluation or exclusive evaluation in an electronic computing unit), embodiments offer the advantage that data processing or at least part of the data processing can take place at the speed of light. The image analysis is, for example, available for the regulation unit in a practically instantaneous manner. Thus, embodiments can circumvent the longer computing times in the computer.

As explained above, embodiments according to the invention solve disadvantages in conventional technology, for example, among others, by performing the process image analysis in an optical neural network (e.g., 110, 210, 310, 332). The information carrier for the (optical) calculation is hence, for example, the light (e.g., in the form of the optical input signal 111, 201, 340, 411, 501) collected from the process zone itself. Thus, the light can pass through an optical system and experience modifications (e.g., in phase and/or amplitude) that can be performed analogously to processing information in a (digital) neural network. A difference is, for example, that information processing takes place at the speed of light, and apart from the used optical elements (e.g., 512, 514) for phase and amplitude manipulation, no further (electronic) hardware is needed for calculation. Depending on the type and number of output quantities of the network, detectors (e.g. 420) with individual pixels, line arrays, or area detectors can be used.

According to embodiments, image recognition and image processing are combined in an optical system, which can consist, for example, of a sequence of conventional optics (e.g., lenses, beam splitters, mirrors, . . . , for example an optical means 230, 520 and/or processing optics 320), diffractive optical elements, DOE (e.g., 512), and also spatial light modulators (SLM) (e.g., 514), such as liquid crystal-based technology or micromirror arrays. The optical neural network, for example in the form of a diffractive optical neural network, DNN, can consist, for example, of a sequence of phase or amplitude masks and can be realized in reflection or transmission with diffractive optical elements (DOE), SLM, or meta-optics both in a static and a dynamic manner. Here, embodiments are not limited to specific diffractive neural networks. According to embodiments, different concepts of a DNN and different types of implementation can be used. According to embodiments, the DNN can be integrated, for example, directly in the monitoring optics (see, for example, FIG. 3A-C). The evaluation can take place, for example, with a CCD chip or, depending on the application, by line detectors or individual photo diodes. The selection of detectors can depend, for example, on the number and type (scalar or binary) of the output parameters of the DNN. The optical system or the optical apparatus can further optionally include one or several wavelength-selective filters (e.g., 220) in order to analyze, for example, only the light of the specific illumination (e.g., 240) of the process. The illumination of the process can optionally take place with a coherent source. In other words, the light source can, for example, be a coherent light source, for example in the form of a laser.

If the optical neural network, for example DNN, includes one or several dynamic elements, for example an SLM, the function of the sensor can be amended, e.g., as regards to time. The adaptation can be used for training the DNN, for example, to adapt the DNN to environmental conditions of the process or for changing the evaluation algorithm, for example with amended quality requirements or amendments of the process (e.g., material, type of product, . . . ).

In the following, among others, further inventive advantages of embodiments compared to conventional solutions will be discussed.

Embodiments can allow an extremely fast image evaluation in process monitoring at the speed of light and can make an electric computing unit obsolete that would otherwise be used for image processing (e.g., including the evaluation of neural networks). The electronic computing unit normally also includes specific hardware, such as graphic processing units (GPU), for fast image evaluation. A respective sensor, for example an optical apparatus or a system according to embodiments, for process monitoring can be built in a very small, compact, and cost-effective manner. A sensor unit can, for example, include a minimum of one or several DOE and a detector, for example a photo diode (that detects, for example, whether a process runs within defined quality criteria). These sensors might not need any connected or integrated electronic computing unit. The sensors can then, for example, be connected directly to the process control. In that way, process parameters, such as process speed, material supply, or laser power, can be changed directly without any detour via a computing unit.

Since in the optical neural network, the calculations for image evaluation can be performed by the process light itself, no further energy is needed. In other words, no further energy will or has to be consumed, for example. The energy consumption of the entire sensor, for example a system according to embodiments, relates, for example only or to a large part, to the evaluation of the detector and optionally additionally to the used illumination.

Thus, embodiments can include in particular laser processing machines and OEM (original equipment manufacturer) in the field of sensor technology or can address such fields of application.

Embodiments include or allow or address further applications, such as: analysis of production processes, environments, objects, for example one that is based on the evaluation of image data by neural networks or that is too slow or too inefficient for such an evaluation.

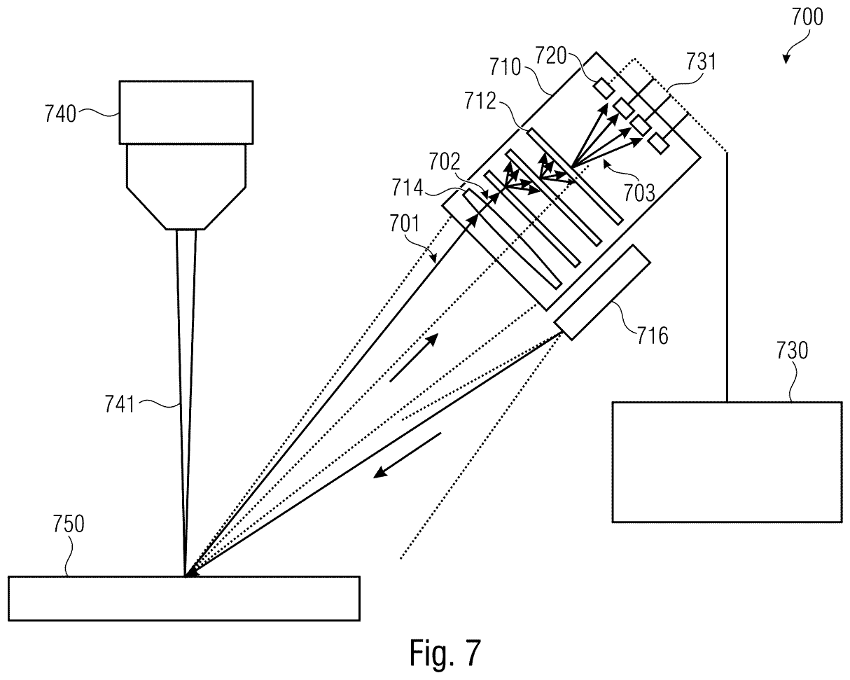

FIG. 7 shows a schematic view of a system according to embodiments with further optional features. The system 700 includes an optical apparatus 710, for example a sensor, with diffractive optical elements 712, optional optical means 714 including, for example, an optical element as well as an optional light source in the form the illumination source 716. Further, the system 700 includes a detector 720. As a further optional feature, the system 700 includes processing means in the form of a plant control 730 as well as signal lines 731.

Further, FIG. 7 shows a processing head 740, for example a laser processing head, as well as a workpiece 750.

Thus, the workpiece 750 can be processed by the processing head 740, for example by means of a laser beam 741. Starting from the workpiece, a signal, which can form the optical input signal 701 or at least part of the optical input signal 701, can be reflected in the direction of the apparatus 710 by the laser beam. Additionally, the input signal 701 can include radiation parts that are radiated by the workpiece itself, for example due to thermal radiation. As a further option, the light source 716 can illuminate the workpiece 750 and hence provide a further part of the input signal 701 based on further reflections. Such an illumination can, for example, also be provided by ambient light (for example daylight or room lighting).

It should be noted again that any combination for generating the optical input signal can be used. For example, radiation reflected by the laser can form the input signal alone (without using an additional light source 716, e.g., in the form of a laser). In a process, such as water jet cutting, for example, only the light source can be used for generating the input signal (as no reflection of laser radiation of a processing laser exists). In all cases, reflected room light, for example, daylight can form the input signal or a part thereof. In other processing operations, the input signal 701 can again be formed only by thermal radiation of the workpiece alone. However, any combination of these input-signal generating options can also be used according to the invention.

In other words, according to embodiments, the scene can be made visible both by active illumination and by the ambient light, or the thermal emissions of the process are analyzed.

Based on the input signal 701, which could, for example, additionally be filtered, for example in a wavelength-selective manner, an optical signal 702, based on which the real-time information 703 is provided, is supplied to the optical neural network, including, for example, the elements 712. The same can be detected by means of the detector 720 and can be passed on to the plant control 730 in electronic form.

Here, it should be noted that the detector 720 can be integrated in the apparatus 710 or also merely in a common housing, for example. An external arrangement is also possible. Based on the detected real-time information, further evaluation can take place in the plant control 730 and/or regulation or control of the operating head 740 (e.g., with respect to speed, power).

For other fields of application, the processing head can, for example, be a cutting head.

All enumerations of materials, environmental influences, electrical properties, and optical properties herein are merely considered to be exemplary and not exclusive.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine readable carrier.

Other embodiments comprise the computer program for performing one of the methods described herein, wherein the computer program is stored on a machine readable carrier.

In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

The apparatuses described herein may be implemented, for example, by using a hardware apparatus or by using a computer or by using a combination of a hardware apparatus and a computer.

The apparatuses described herein or any components of the apparatuses described herein may be implemented at least partly in hardware and/or software (computer program).

The methods described herein may be implemented, for example, by using a hardware apparatus or by using a computer or by using a combination of a hardware apparatus and a computer.

The methods described herein or any components of the methods described herein may be performed at least partly by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

| | |
|---|---|
| U.S. Pat. No. | Real time process control of optical components |
| 6,597,449B1 | using linearly swept tunable laser |
| U.S. Pat. No. | Method and apparatus for real-time control of |
| 5,517,420A | laser processing of materials |
| CA2467221A1 | Method and system for real-time monitoring and |
| | controlling height of deposit by using image |
| | photographing and image processing technology |
| | in laser cladding and laser-aided direct |
| | metal manufacturing process |
| CN000216680796U | Laser power real-time online monitoring device |
| | and laser processing system |
| CN000214161805U | Laser processing quality monitoring system |
| CN000210967526U | System for monitoring laser processing |
| | performance in real time |
| CN000206775660U | Three cascade optical network monitoring devices |
| CN000203981562U | Real-time monitoring device for interaction |
| | process between optical material and laser |
| CN000201052570Y | Real time monitoring device for three-dimensional |
| | laser welding and cutting process |
| CN000114549479A | Process monitoring system and method for |
| | laser additive remanufacturing equipment |
| CN000114486687A | Multi-scale continuous observation feedback |
| | method and device for femtosecond laser |
| | processing of cells |
| CN000114450120A | Laser processing monitoring method and |
| | laser processing monitoring device |
| CN000203981562U | Real-time monitoring device for interaction |
| | process between optical material and laser |
| CN000114549479A | Process monitoring system and method for |
| | laser additive remanufacturing equipment |

Knaak et Al., “A Spatio-Temporal Ensemble Deep Learning Architecture for Real-Time Defect Detection during Laser Welding on Low Power Embedded Computing Boards”, Sensors, 2021
Schindhelm, “In-Prozess Qualitätssicherung für das Laserstrahlschneiden von Metallen”, Herbert Utz, 2014
Gehrke, “Überwachung der Struktureigenschaften beim Oberflächenstrukturieren mit ultrakurzen Laserpulsen”, Herbert Utz, 2013
Lin et al., “All-optical machine learning using diffractive deep neural networks”, Science, 2018
Chen et al., “Diffractive Deep Neural Networks at Visible Wavelengths”, Engineering, 2021

1. Optical apparatus for providing optical real-time information regarding a process;
wherein the optical apparatus is configured to detect an optical input signal that is radiated and/or reflected by the process;
wherein the optical apparatus comprises an optical neural network that is configured to provide the optical real-time information regarding the process based on the optical input signal;
wherein the process is a controlled and/or regulated process; and
wherein the optical neural network is configured to determine, based on the optical input signal, a control signal and/or a regulation signal and to encode the control signal and/or the regulation signal into the optical real-time information.

2. Optical apparatus according to claim 1,
wherein the optical apparatus is configured to capture the optical input signal immediately before the process for detecting the optical input signal that is radiated and/or reflected by the process.

3. Optical apparatus according to claim 1, further comprising:
optical unit configured to acquire the optical input signal and to provide, based on the input signal, an optical signal for determining the real-time information to the optical neural network.

4. Optical apparatus according to claim 3,
wherein the optical unit comprises at least one of a lens, a beam splitter, a mirror, a wavelength filter and/or an aperture.

5. Optical apparatus according to claim 1,
wherein the process comprises beam-forming of a process beam by means of processing optics; and
wherein the optical apparatus is configured to acquire the optical input signal via the processing optics and/or via individual optical partial elements of the processing optics.

6. Optical apparatus according to claim 5,
wherein the optical apparatus comprises a beam splitter;
wherein the beam splitter is configured to acquire the optical input signal via the processing optics and/or via individual optical partial elements of the processing optics; and
wherein the optical apparatus is configured to separate the optical input signal from the process beam by means of the beam splitter; and
wherein the optical apparatus is configured to provide the optical input signal to the optical neural network by means of the beam splitter.

7. Optical apparatus according to claim 1,
wherein the optical neural network comprises at least one of a diffractive optical element, a spatial light modulator and/or meta-optics.

8. Optical apparatus according to claim 1,
wherein the optical neural network is configured to determine a process parameter based on the optical input signal and to encode the process parameter into the optical real-time information.

9. Optical apparatus according to claim 1,
wherein the optical apparatus is configured to modify a phase and/or amplitude of the optical input signal to provide the optical real-time information in the form of a light point, a line beam and/or a two-dimensional light array.

10. Optical apparatus according to claim 1,
wherein the optical neural network comprises at least one static optical element and at least one adaptable optical element; and
wherein the adaptable optical element is configured to change the processing of the optical input signal in the optical neural network.

11. Optical apparatus according to claim 1, further comprising:
an optical filter that is configured to filter the optical input signal in a wavelength-selective manner to provide a filtered optical input signal to the optical neural network.

12. Optical apparatus according to claim 1, further comprising:
a light source, wherein the light source is configured to illuminate the process to generate the optical input signal that is radiated and/or reflected by the process.

13. Optical apparatus according to claim 13,
wherein the optical neural network is configured to process light with a specific optical property; and
wherein the light source is configured to provide the light with the specific optical property.

14. Optical apparatus according to claim 12,
wherein the optical apparatus comprises a beam splitter, the beam splitter or a further beam splitter;
wherein the optical apparatus is configured to separate the light of the light source from the optical input signal by means of the beam splitter or the further beam splitter; and
wherein the optical apparatus is configured to provide the optical input signal to the optical neural network by means of the beam splitter or the further beam splitter.

15. Optical apparatus according to claim 1,
wherein the optical apparatus is configured to be supplied with energy for providing the optical real-time information exclusively by means of the optical input signal;

16. Optical system, comprising:
an optical apparatus according to claim 1;
a detector configured to detect the optical real-time information and to provide an electric signal based on the optical real-time information;
wherein the detector comprises at least one of a photo diode, a line detector, and/or an area detector.

17. Optical system according to claim 16, further comprising:
processor configured to
control and/or regulate the process on the basis of the electric signal of the detector; and/or
provide information regarding the process on the basis of the electric signal of the detector.

18. Optical system according to claim 17,
wherein the process is a material processing process and/or a measurement process by using a laser and wherein the processor is configured to control and/or regulate the laser on the basis of the electric signal of the detector,

19. Method for providing an optical apparatus,
wherein the optical apparatus comprises an optical neural network configured to provide optical real-time information regarding the process based on an optical input signal that is radiated and/or reflected by a process;
wherein the optical neural network comprises at least one first optical element and at least one adaptable optical element;
wherein the method comprises:
simulative pre-training of a virtual model of the optical neural network with a first set of training data, wherein the at least one first optical element and the at least one adaptable optical element are mapped in the virtual model; and
generating the optical neural network based on the pre-trained model;
adapting the at least one adaptable optical element in the virtual pre-trained model of the optical neural network based on a simulative training of the virtual pre-trained model with a second set of training data; and
adapting the at least one adaptable optical element of the optical neural network in accordance with the adapted virtual model of the optical neural network to provide the optical apparatus.

20. Method according to claim 19,
wherein the at least one first optical element is a static or adaptable optical element.

21. Method according to claim 19, further comprising:
generating the first and/or second set of training data by using a camera detecting the optical input signal via the optical unit; and
using the optical unit to provide an optical signal for determining the real-time information to the optical neural network based on the optical input signal.

22. Method according to claim 19, further comprising:
generating the first and/or second set of training data by using a camera detecting the optical input signal via the optical unit; and
using the same optical unit to provide, based on the optical input signal, an optical signal for determining the real-time information to the optical neural network.

23. Optical apparatus for providing optical real-time information regarding a process;
wherein the process is a material processing process and/or a measurement process by using a laser where a workpiece is measured or processed;
wherein the optical apparatus is configured to detect an optical input signal that is radiated and/or reflected by the process; and
wherein the optical apparatus comprises an optical neural network that is configured to provide the optical real-time information regarding the process based on the optical input signal.

24. Optical apparatus for providing optical real-time information regarding a process;
wherein the process is a material processing process and/or a measurement process by using a laser; and
wherein the optical apparatus is configured to detect an optical input signal that is radiated and/or reflected by the process; and
wherein the optical apparatus comprises an optical neural network that is configured to provide the optical real-time information regarding the process based on the optical input signal;
wherein the optical apparatus is configured to capture the optical input signal immediately before the process for detecting the optical input signal that is radiated and/or reflected by the process.

25. Optical apparatus according to claim 24,
wherein the process is a controlled and/or regulated process; and
wherein the optical neural network is configured to determine a control signal and/or a regulation signal for the material processing process and/or the measurement process based on the optical input signal and to encode the control signal and/or the regulation signal in the optical real-time information.

26. Optical apparatus for providing optical real-time information regarding a process;
wherein the process is a material processing process and/or a measurement process using a laser; and
wherein the optical apparatus is configured to detect an optical input signal that is radiated and/or reflected by the process; and
wherein the optical apparatus comprises an optical neural network that is configured to provide the optical real-time information regarding the process based on the optical input signal;
wherein the process comprises beam forming of a process beam by means of processing optics; and
wherein the processing optics is configured to form the process beam and guide the same to a workpiece;
wherein the optical apparatus comprises a beam splitter;
wherein the beam splitter is configured to acquire the optical input signal in the form of radiation that is radiated and/or reflected by the workpiece via the processing optics and/or via individual optical partial elements of the processing optics; and
wherein the optical apparatus is configured to separate the optical input signal from the process beam by means of the beam splitter; and
wherein the optical apparatus is configured to provide the optical input signal to the optical neural network by means of the beam splitter.

27. Optical apparatus for providing optical real-time information regarding a process;
wherein the optical apparatus is configured to detect an optical input signal that is radiated and/or reflected by the process;
wherein the optical apparatus comprises an optical neural network that is configured to provide the optical real-time information regarding the process based on the optical input signal;
wherein the process comprises beam-forming of a process beam by means of processing optics; and
wherein the optical apparatus is configured to acquire the optical input signal via the processing optics and/or via individual optical partial elements of the processing optics; and
wherein the optical neural network is configured to evaluate the optical input signal directly in the processing optics, and to output an intensity pattern into which the results of the evaluation or new control and/or regulation signals for the process are encoded.
